(19) United States
(12) Patent Application Publication
(10) Pub. No.: US 2021/0033907 A1
(43) Pub. Date: Feb. 4, 2021

(54) DISPLAY PANEL AND METHOD FABRICATING SAME

(71) Applicant: Wuhan China Star Optoelectronics Technology Co.,Ltd., Wuhan, Hubei (CN)

(72) Inventor: Bingkun YIN, Wuhan,Hubei (CN)

(21) Appl. No.: 16/623,381

(22) PCT Filed: Nov. 5, 2019
(86) PCT No.: PCT/CN2019/115736

§ 371 Date: Dec. 16, 2019

(30) Foreign Application Priority Data
Jul. 31, 2019 (CN) 201910701059.6

(51) Int. Cl. G02F 1/1339; G02F 1/1335; G02F 1/1368; G02F 1/1341

(52) U.S. Cl. CPC G02F 1/13394; G02F 1/133516; G02F 1/133512; G02F 1/1368; G02F 2001/136236; G02F 2001/13398; G02F 2001/13396; G02F 2201/50; G02F 2201/123; G02F 1/1341

(57) ABSTRACT

The present disclosure provides a display panel and a fabricating method thereof, wherein the display panel includes a first substrate and a second substrate, the first substrate is provided with a plurality of first spacers, and the second substrate is provided with a plurality of second spacers disposed corresponding to the first spacers, a recess is disposed on a side of the second spacers adjacent to the first substrate, and an end of the first spacers away from the first substrate is placed in the recess, so that a relative displacement between the first substrate and the second substrate is reduced when the display panel is bent, thereby improving the problems of light leakage and color mixing, and reducing a risk of scratching an alignment film when the spacers slide.

### BACKGROUND OF INVENTION

### Field of Invention

The present disclosure relates to a field of display technologies, and in particular, to a display panel and a method of fabricating the same.

### Description of Prior Art

With the development of display technology, a flexible display has attracted wide attention in the industry. Compared with a flat display, the flexible display has a wider viewing angle, which can reduce distortion of close-range viewing, and can realize product differentiation.

However, when a liquid crystal display panel is bent, a relative displacement between the array substrate and the color filter substrate may occur and cause misalignment, where light leakage or color mixing may occur, seriously impacting the display effect. A display panel of the prior art blocks light by increasing a size of black matrix; or, by providing spacers on one side of an array substrate to form an interlocking structure with spacers disposed on one side of a color filter substrate, thereby reducing risk of light leakage. However, increasing the size of the black matrix will result in a decrease in an aperture ratio of the display panel, and the design of the interlocking structure has a risk of scratching an alignment film when the spacers slide.

In summary, it is necessary to provide a new display panel and a fabricating method thereof to solve the above technical problems.

### SUMMARY OF INVENTION

The present disclosure provides a display panel and a fabricating method thereof, which solves the technical problem that light leakage or color mixing occurs when an array substrate and a color filter substrate are relatively displaced when the display panel is bent.

In order to solve the above problems, the technical solution provided by the present disclosure is as follows:

This embodiment of the present disclosure provides a display panel including a first substrate and a second substrate disposed opposite to each other;

wherein a plurality of first spacers are disposed on the first substrate, a plurality of second spacers corresponding to the first spacers are disposed on the second substrate, a recess is disposed on a side of the second spacers adjacent to the first substrate, and an end of the first spacers away from the first substrate is placed in the recess, so that a relative position between the first substrate and the second substrate is fixed, and a plurality of support pillars are disposed at a sealant region between the first substrate and the second substrate.

In the display panel according to an embodiment of the present disclosure, one of the first substrate and the second substrate is a color filter substrate, and another one is an array substrate, wherein, the color filter substrate includes a plurality of color resists and a black matrix disposed between adjacent ones of the color resists, and the array substrate includes a thin film transistor array layer and a pixel electrode layer disposed on the thin film transistor array layer.

In the display panel according to an embodiment of the present disclosure, a depth of the recess in a first direction is smaller than a height of the second spacers in the first direction, wherein the first direction is referred to a direction from the first substrate to the second substrate, and a second direction is referred to a direction perpendicular to the first direction.

In the display panel according to an embodiment of the present disclosure, the end of the first spacers away from the first substrate and a bottom end of the recess have a same size in the second direction.

In the display panel according to an embodiment of the present disclosure, the first spacers have a cross-sectional shape of an inverted trapezoid, and the first spacers have a cross-sectional area gradually decreasing in the first direction.

In the display panel according to an embodiment of the present disclosure, the end of the first spacers away from the first substrate is attached to a bottom end of the recess.

In the display panel according to an embodiment of the present disclosure, the first substrate is a color filter substrate, the second substrate is an array substrate, and the first substrate further includes a protective layer, wherein the protective layer is disposed on the color resist layer, an end of the first spacers adjacent to the first substrate is located in the protective layer, and the end of the first spacers away from the first substrate is higher than a surface of the protective layer.

This embodiment of the present disclosure provides a display panel including a first substrate and a second substrate disposed opposite to each other;

wherein a plurality of first spacers are disposed on the first substrate, a plurality of second spacers corresponding to the first spacers are disposed on the second substrate, a recess is disposed on a side of the second spacers adjacent to the first substrate, and an end of the first spacers away from the first substrate is placed in the recess, so that a relative position between the first substrate and the second substrate is fixed.

In the display panel according to an embodiment of the present disclosure, one of the first substrate and the second substrate is a color filter substrate, and the other one is an array substrate, wherein the color filter substrate includes a plurality of color resists and a black matrix disposed between adjacent ones of the color resists, and the array substrate includes a thin film transistor array layer and a pixel electrode layer disposed on the thin film transistor array layer.

In the display panel according to an embodiment of the present disclosure, a depth of the recess in a first direction is smaller than a height of the second spacers in the first direction, wherein the first direction is referred to a direction from the first substrate to the second substrate, and a second direction is referred to a direction perpendicular to the first direction.

In the display panel according to an embodiment of the present disclosure, a depth of the recess in the first direction is 0.5 to 1.5 um, and a height of the second spacers in the first direction is 1 to 2 um.

In the display panel according to an embodiment of the present disclosure, the end of the first spacers away from the first substrate and a bottom end of the recess have a same size in the second direction.

In the display panel according to an embodiment of the present disclosure, the first spacers have a cross-sectional shape of an inverted trapezoid, and the first spacers have a cross-sectional area gradually decreasing in the first direction.

In the display panel according to an embodiment of the present disclosure, the end of the first spacers away from the first substrate is attached to a bottom end of the recess.

In the display panel according to an embodiment of the present disclosure, the first substrate is a color filter substrate, the second substrate is an array substrate, and the first substrate further includes a protective layer, wherein the protective layer is disposed on the color resist layer, an end of the first spacers adjacent to the first substrate is located in the protective layer, and the end of the first spacers away from the first substrate is higher than a surface of the protective layer.

In the display panel according to an embodiment of the present disclosure, the first spacers have a shape of any one of a round table, a prism, and a step.

In the display panel according to an embodiment of the present disclosure, the recess has a cross-sectional shape of any one of a rectangle, a semicircle, and a trapezoid.

An embodiment of the present disclosure provides a method of fabricating a display panel, which includes the following steps:

step S10: forming a first substrate, and forming a first spacers on the first substrate;

step S20: forming a second substrate, forming a second spacers on the second substrate, and forming a recess on the second spacer; and

step S30: assembling the first substrate and the second substrate, and disposing a liquid crystal layer between the first substrate and the second substrate.

In the method of fabricating a display panel according to an embodiment of the present disclosure, the step S10 includes the following steps:

step S101: providing the first substrate, sequentially forming a plurality of color resists on the first substrate, a black matrix between adjacent ones of the color resists, and a protective layer on the color resists; and

step S102: forming the first spacers on the black matrix.

In the method of fabricating a display panel according to an embodiment of the present disclosure, the step S20 includes the following steps:

step S201: providing the second substrate, and sequentially forming a thin film transistor array layer, a pixel electrode layer, and an organic layer on the second substrate; and

step S202: exposing, developing, and ashing the organic layer to form the second spacers by a halftone mask process, and forming a recess on the second spacers.

The present disclosure provides a display panel and a fabricating method thereof, by providing first spacers and second spacers on the first substrate and the second substrate respectively, wherein a recess is disposed on a side of the second spacers adjacent to the first substrate, and an end of the first spacers away from the first substrate is placed in the recess, a relative position between the first substrate and the second substrate is fixed, so that when a liquid crystal display panel is bent, a relative displacement between the array substrate and the color filter substrate is reduced, improving the defects of light leakage or color mixing, and preventing a risk of scratching an alignment film when the first spacers slide.

### BRIEF DESCRIPTION OF DRAWINGS

In order to more clearly illustrate the embodiments or the technical solutions of the existing art, the drawings illustrating the embodiments or the existing art will be briefly described below. Obviously, the drawings in the following description merely illustrate some embodiments of the present invention. Other drawings may also be obtained by those skilled in the art according to these figures without paying creative work.

FIG. 1 is a schematic cross-sectional structural view of a display panel according to an embodiment of the present disclosure.

FIG. 2 is a schematic cross-sectional structural view of a second spacers according to an embodiment of the present disclosure.

FIG. 3A is a schematic view showing a positional relationship between a first spacers and a second spacers according to an embodiment of the present disclosure.

FIG. 3B is a schematic view showing a positional relationship between a first spacers and a second spacers according to another embodiment of the present disclosure.

FIG. 3C is a schematic view showing a positional relationship between a first spacers and a second spacers according to further another embodiment of the present disclosure.

FIG. 4 is a schematic cross-sectional structural view of a display panel according to an embodiment of the present disclosure.

FIG. 5 is a schematic cross-sectional structural view of a display panel when it is bent according to an embodiment of the present disclosure.

FIG. 6 is a schematic cross-sectional structural view of a display panel according to an embodiment of the present disclosure.

FIG. 7 is a flowchart of a method of fabricating a display panel according to an embodiment of the present disclosure.

### DETAILED DESCRIPTION OF PREFERRED EMBODIMENTS

The following description of the various embodiments is provided to illustrate the specific embodiments of the invention. Directional terms mentioned in the present invention, such as “vertical”, “horizontal”, “upper”, “bottom”, “pre”, “post”, “left”, “right”, “inside”, “outside”, “side”, etc., only refer to the direction of the additional drawing. Therefore, the directional terminology used is for the purpose of illustration and understanding of the invention. In the figures, structurally similar elements are denoted by the same reference numerals.

The present disclosure is directed to solving a technical problem of a display panel in the prior art and a fabricating method thereof that when the display panel is bent, a relative displacement between the array substrate and the color filter substrate may occur and cause light leakage or color mixing.

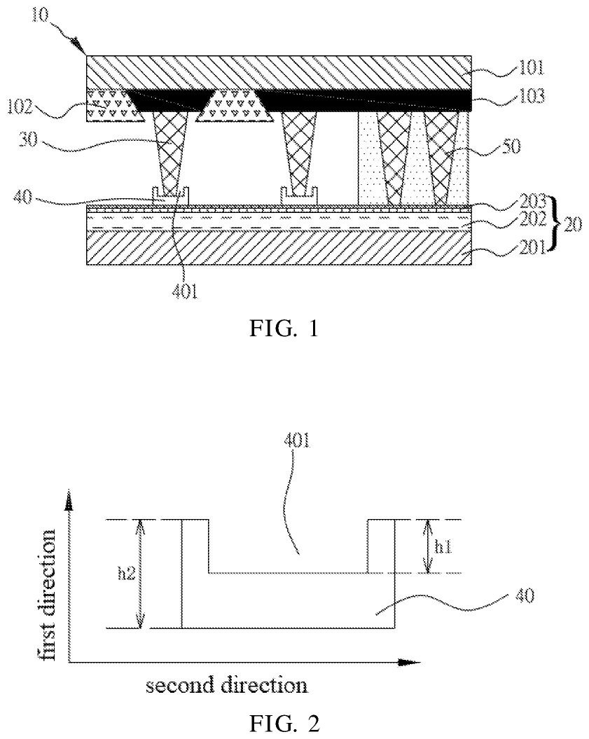

As shown in FIG. 1, a display panel provided by an embodiment of the present disclosure includes a first substrate 10, a second substrate 20 disposed opposite to the first substrate 10, and a liquid crystal layer (not shown) disposed between the first substrate 10 and the second substrate 20.

One of the first substrate 10 and the second substrate 20 is a color filter substrate, and another one is an array substrate, wherein the color filter substrate includes a plurality of color resists 102 and a black matrix 103 disposed between adjacent ones of the color resists 102, the plurality of the color resists 102 include a red, green, and blue resists, the array substrate includes a thin film transistor array layer 202 and a pixel electrode layer 203 disposed on the thin film transistor array layer 202, the liquid crystal layer includes a plurality of liquid crystal molecules, transmittance of the liquid crystal molecules is controlled by the pixel electrode layer 203, and light is filtered by the color resists 102 to display an image.

A plurality of first spacers 30 are disposed on the first substrate 10, a plurality of second spacers 40 corresponding to the first spacers 30 are disposed on the second substrate 20, a recess 401 is disposed on a side of the second spacers 40 adjacent to the first substrate 10, and an end of the first spacers 30 away from the first substrate 10 is placed in the recess 401, so that a relative position between the first substrate 10 and the second substrate 20 is fixed.

With such a structural design, the end of the first spacers 30 can be restricted in the recess 401. On the one hand, when the display panel is bent, a sidewall of the recess 401 can prevent the first spacers 30 from sliding on the second substrate 20 to avoid misalignment between the first substrate 10 and the second substrate 20, causing light leakage or color mixing. On the other hand, the first spacers 30 are prevented from scratching the alignment film on the second substrate 20.

In an embodiment, the first substrate 10 is a color filter substrate, and the second substrate 20 is an array substrate. Specifically, the first substrate 10 includes a first base 101, a plurality of color resists 102 disposed on the first base 101, and a black matrix 103 disposed between adjacent ones of the color resists 102; and the second substrate 20 includes a second base 201, a thin film transistor array layer 202 disposed on the second base 201, and a pixel electrode layer 203 disposed on the thin film transistor array layer 202. The first spacers 30 are disposed on the black matrix 103, the second spacers 40 are disposed on the pixel electrode layer 203, a recess 401 is disposed on a side of the second spacers 40 adjacent to the first substrate 10, and the recess 401 is disposed corresponding to the first spacers 30, so that one end of the first spacers 30 away from the first substrate 10 can be placed into the recess 401, and when the display panel is bent, a relative displacement between the first substrate 10 and the second substrate 20 is decreased.

As shown in FIG. 2, a depth of the recess 401 in a first direction is smaller than a height of the second spacers 40 in the first direction, such that a plane at which a bottom end of the recess 401 is disposed is higher than a surface of the pixel electrode layer 203. When the display panel is subjected to a large compressive stress, even if the first spacers 30 are separated from the recess 401, they do not damage the alignment layer located on the pixel electrode layer 203. The first direction is referred to a direction from the first substrate 10 to the second substrate 20, and a second direction is referred to a direction perpendicular to the first direction. In this embodiment, the first direction is referred to a direction from the color filter substrate to the array substrate.

Specifically, the depth h1 of the recess 401 in the first direction is 0.5 to 1.5 um, and the height h2 of the second spacers 40 in the first direction is 1 to 2 um.

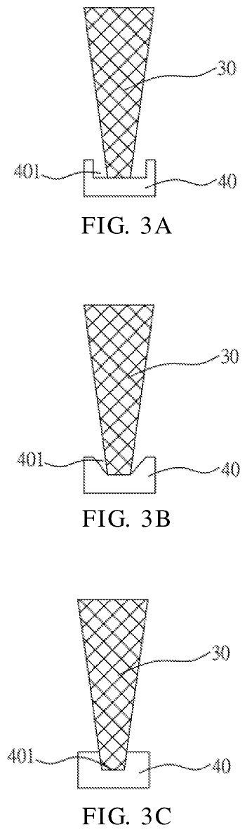

The end of the first spacers away from the first substrate and a bottom end of the recess may have a same size or different sizes in the second direction. For example, as shown in FIG. 3A. a dimension of the end of the first spacers 30 away from the first substrate 10 is greater than a dimension of the bottom end of the recess 401 in the second direction; and for further example, as shown in FIG. 3B and FIG. 3C, a dimension of the end of the first spacers 30 away from the first substrate 10 is equal to a dimension of the bottom end of the recess 401 in the second direction, such that the first spacers 30 are defined in the recess 401 and the stability is improved.

The first spacers 30 have a cross-sectional area gradually decreasing in the first direction. Optionally, the first spacers 30 have a cross-sectional shape of an inverted trapezoid. Accordingly, the first spacers 30 have a cross-sectional shape of any one of a circular table, a prism, and a step. Optionally, the width of the cross section of the first spacers 30 is smaller than the width of the black matrix 103 to ensure the first spacers 30 do not impact normal operation of the color resist 102.

Further, as shown in FIG. 3C, the end of the first spacers 30 away from the first substrate 10 and the bottom end of the recess 401 are adhered to each other. It should be noted that a side surface of the recess 401 is attached to a side surface of the first spacers 30 to further restrict the sliding of the first spacers 30 on the array substrate to improve the stability. A cross-sectional shape of the recess 401 may be any one of a rectangular shape, a semicircular shape, and a trapezoidal shape.

Still referring to FIG. 1, a plurality of support pillars 50 are provided at a sealant region between the first substrate 10 and the second substrate 20 for controlling a thickness of the display panel. the support pillars 50 have one end disposed on the first substrate 10, and another end disposed on the second substrate 20. In this embodiment, the support pillars 50 can be made by the same process as the first spacers 30, and the support pillars 50 can be made of same material as the first spacers 30.

It can be understood that, since the recess 401 of the second spacers 40 has a certain height in the first direction, under the premise of ensuring the cell gap of the display panel, a height of the first spacers 30 in the first direction can be reduced, thereby reducing the sliding of the first spacers 30 on the array substrate, increasing rigidity strength, thus reducing a risk of scratching an alignment film caused by the sliding of the restricted first spacers 30.

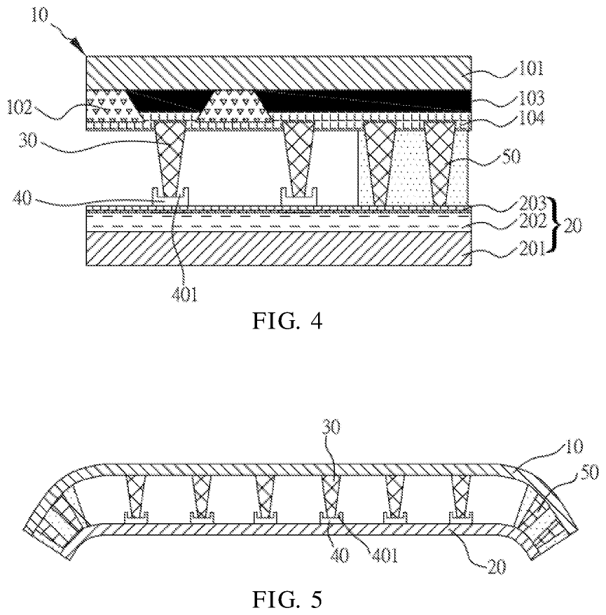

Further, as shown in FIG. 4, the first substrate 10 further includes a protective layer 104, wherein the protective layer 104 is disposed on the color resist 102, an end of the first spacers 30 adjacent to the first substrate 10 may be located in the protective layer 104, and an end of the first spacers 30 away from the first substrate 10 is higher than a surface of the protective layer 104.

FIG. 5 is a schematic cross-sectional view showing a structure of a display panel according to an embodiment of the present disclosure. An anchoring structure formed of the first spacers 30 and the second spacers 40 can restrict the sliding of the first spacers 30 on the array substrate, thereby avoiding the problem that the first substrate 10 and the second substrate 20 are displaced to cause light leakage or color mixture.

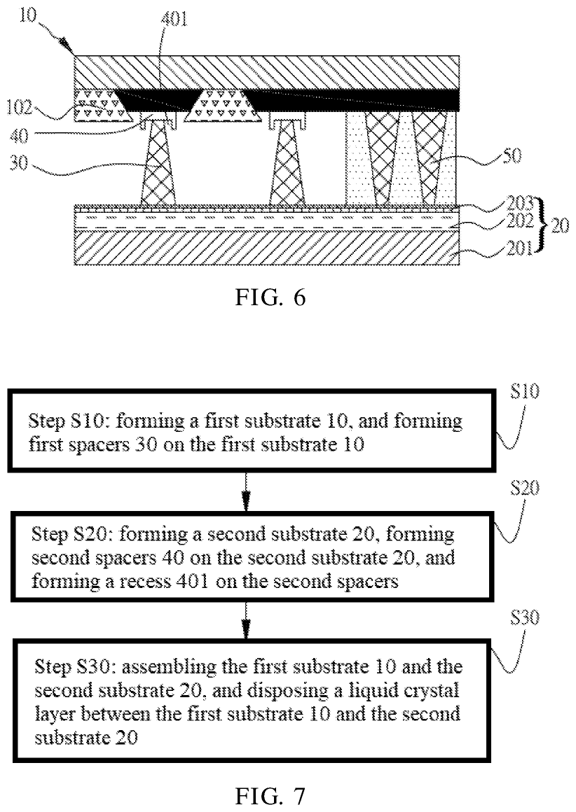

As shown in FIG. 6, in another embodiment, the first substrate 10 is an array substrate, and the second substrate 20 is a color film substrate. This embodiment is different from the previous embodiment in that the first spacers 30 are disposed on the pixel electrode layer 203, and the second spacers 40 are disposed on the black matrix 103, and in the meanwhile a recess 401 is formed on one side of the color filter substrate. The principle of the first spacers 30 disposed on the array substrate is the same as that of the first spacers 30 disposed on the color filter substrate, and not repeated herein for brevity.

As shown in FIG. 7, an embodiment of the present disclosure further provides a method of fabricating a display panel. In order to accurately describe the technical solution of the present application, this embodiment of the present disclosure is exemplified by the first substrate 10 being a color filter substrate, and the second substrate 20 being an array substrate. The fabricating method includes the following steps:

Step S10: forming a first substrate 10, and forming first spacers 30 on the first substrate 10.

Specifically, the step S10 includes the following steps:

Step S101: providing a first base 101, sequentially forming a plurality of color resists 102 on the first base 101, a black matrix 103 located between adjacent ones of the color resists 102, and a protective layer 104 located on the color resists 102.

The color resists 102, the black matrix 103 located between the adjacent ones of the color resists 102, and a protective layer 104 located on the color resists 102 sequentially formed on the first base 101 by the processes such as coating, exposure, development, and etching.

Step S102: forming the first spacers 30 on the black matrix 103.

A layer of material for forming the first spacers 30 is first coated on the protective layer 104, and then the first spacers 30 may be formed by a halftone mask process.

Step S20: forming a second substrate 20, forming second spacers 40 on the second substrate 20, and forming a recess 401 on the second spacers.

Specifically, the step S20 includes the following steps:

Step S201: providing a second base 201, and sequentially forming a thin film transistor array layer 202, a pixel electrode layer 203, and an organic layer on the second base 201.

The thin film transistor array layer 202, the pixel electrode layer 203, and the organic layer are sequentially formed on the second base 201 by the processes such as coating, exposure, development, and etching, and the organic layer covers the surface of the pixel electrode layer 203.

Step S202: exposing, developing, and ashing the organic layer to form the second spacers 40 by a halftone mask process, and forming a recess 401 on the second spacers.

Most of the material of the organic layer is removed using the halftone mask process, and then the recess 401 is opened on the remaining portion of the organic layer.

Step S30: assembling the first substrate 10 and the second substrate 20, and disposing a liquid crystal layer between the first substrate 10 and the second substrate 20.

This embodiment of the present disclosure further provides a display device, which includes the display panel in the above embodiments, and the display device may be an electronic device such as a mobile phone, a computer, a radio, a calculator, or the like.

The beneficial effect is: the present disclosure provides a display panel and a fabricating method thereof, by providing first spacers and second spacers on the first substrate and the second substrate respectively, wherein a recess is disposed on a side of the second spacers adjacent to the first substrate, and an end of the first spacers away from the first substrate is placed in the recess, a relative position between the first substrate and the second substrate is fixed, so that when a liquid crystal display panel is bent, a relative displacement between the array substrate and the color filter substrate is reduced, improving the defects of light leakage or color mixing, and preventing a risk of scratching an alignment film when the first spacers slide.

While the invention has been described by way of example and in terms of the preferred embodiments, it is to be understood that the invention is not limited to the disclosed embodiments. To the contrary, it is intended to cover various modifications and similar arrangements. Therefore, the scope of the appended claims should be accorded the broadest interpretation so as to encompass all such modifications and similar arrangements.

What is claimed is:

1. A display panel, comprising:
a first substrate;
a second substrate disposed opposite to each other,
a plurality of first spacers disposed on the first substrate;
a plurality of second spacers corresponding to the first spacers disposed on the second substrate;
a recess disposed on a side of the second spacers adjacent to the first substrate, wherein an end of the first spacers away from the first substrate is placed in the recess, so that a relative position between the first substrate and the second substrate is fixed; and
a plurality of support pillars disposed at a sealant region between the first substrate and the second substrate.

2. The display panel according to claim 1, wherein one of the first substrate and the second substrate is a color filter substrate, and another one of the first substrate and the second substrate is an array substrate, the color filter substrate comprises a plurality of color resists and a black matrix disposed between adjacent ones of the color resists, and the array substrate comprises a thin film transistor array layer and a pixel electrode layer disposed on the thin film transistor array layer.

3. The display panel according to claim 2, wherein a depth of the recess in a first direction is smaller than a height of the second spacers in the first direction, the first direction is referred to a direction from the first substrate to the second substrate, and a second direction is referred to a direction perpendicular to the first direction.

4. The display panel according to claim 3, wherein the end of the first spacers away from the first substrate and a bottom end of the recess have a same size in the second direction.

5. The display panel according to claim 3, wherein the first spacers have a cross-sectional shape of an inverted trapezoid, and the first spacers have a cross-sectional area gradually decreasing in the first direction.

6. The display panel according to claim 1, wherein the end of the first spacers away from the first substrate is attached to a bottom end of the recess.

7. The display panel according to claim 2, wherein the first substrate is a color filter substrate, the second substrate is an array substrate, and the first substrate further comprises a protective layer, wherein the protective layer is disposed on the color resist layer, an end of the first spacers adjacent to the first substrate is located in the protective layer, and the end of the first spacers away from the first substrate is higher than a surface of the protective layer.

8. A display panel, comprising a first substrate and a second substrate disposed opposite to each other,
wherein a plurality of first spacers are disposed on the first substrate, a plurality of second spacers corresponding to the first spacers are disposed on the second substrate, a recess is disposed on a side of the second spacers adjacent to the first substrate, and an end of the first spacers away from the first substrate is placed in the recess, so that a relative position between the first substrate and the second substrate is fixed.

9. The display panel according to claim 8, wherein one of the first substrate and the second substrate is a color filter substrate, and the other one is an array substrate, the color filter substrate comprises a plurality of color resists and a black matrix disposed between adjacent ones of the color resists, and the array substrate comprises a thin film transistor array layer and a pixel electrode layer disposed on the thin film transistor array layer.

10. The display panel according to claim 9, wherein a depth of the recess in a first direction is smaller than a height of the second spacers in the first direction, the first direction is referred to a direction from the first substrate to the second substrate, and a second direction is referred to a direction perpendicular to the first direction.

11. The display panel according to claim 10, wherein a depth of the recess in the first direction ranges from 0.5 to 1.5 um, and a height of the second spacers in the first direction ranges from 1 to 2 um.

12. The display panel according to claim 10, wherein the end of the first spacers away from the first substrate and a bottom end of the recess have a same size in the second direction.

13. The display panel according to claim 10, wherein the first spacers have a cross-sectional shape of an inverted trapezoid, and the first spacers have a cross-sectional area gradually decreasing in the first direction.

14. The display panel according to claim 8, wherein the end of the first spacers away from the first substrate is attached to a bottom end of the recess.

15. The display panel according to claim 9, wherein the first substrate is a color filter substrate, the second substrate is an array substrate, and the first substrate further comprises a protective layer, wherein the protective layer is disposed on the color resist layer, an end of the first spacers adjacent to the first substrate is located in the protective layer, and the end of the first spacers away from the first substrate is higher than a surface of the protective layer.

16. The display panel according to claim 8, wherein the first spacers have a shape of any one of a round table, a prism, and a step.

17. The display panel according to claim 8, wherein the recess has a cross-sectional shape of any one of a rectangle, a semicircle, and a trapezoid.

18. A method of fabricating the display panel of claim 8, comprising the steps of:
step S10: forming the first substrate, and forming the plurality of first spacers on the first substrate;
step S20: forming the second substrate, forming the plurality of second spacers on the second substrate, and forming the recess on the second spacers; and
step S30: assembling the first substrate and the second substrate, and disposing a liquid crystal layer between the first substrate and the second substrate.

19. The method of fabricating the display panel according to claim 18, wherein the step S10 comprises the following steps:
step S101: providing a first base, sequentially forming a plurality of color resists on the first base, a black matrix between adjacent ones of the color resists, and a protective layer on the color resists; and
step S102: forming the first spacers on the black matrix.

20. The method of fabricating the display panel according to claim 18, wherein the step S20 comprises the following steps:
step S201: providing a second base, and sequentially forming a thin film transistor array layer, a pixel electrode layer, and an organic layer on the second base; and
step S202: exposing, developing, and ashing the organic layer to form the second spacers by a halftone mask process, and forming the recess on the second spacers.
